(19) United States
(12) Patent Application Publication
(10) Pub. No.: US 2017/0302223 A1
(43) Pub. Date: Oct. 19, 2017

(54) SOLAR PANEL STEALTH AND HEAT MANAGEMENT

(71) Applicant: AMERISTAR SOLAR, LLC, BANKS, OR (US)

(72) Inventor: SIDNEY WILLIAM BOYK, BANKS, OR (US)

(21) Appl. No.: 15/293,606

(22) Filed: Oct. 14, 2016

Related U.S. Application Data
(60) Provisional application No. 62/242,787, filed on Oct. 16, 2015.

(51) Int. Cl. H02S 40/20; H02S 10/40; H02S 20/30; H02S 40/42

(52) U.S. Cl. CPC H02S 40/20; H02S 40/42; H02S 10/40; H02S 20/30

(57) ABSTRACT

A solar panel assembly has a frame, a solar panel attached to the frame, the solar panel having a front side to collect solar energy and a back side opposite the front side, a first non-reflective honeycomb adjacent the front side and attached to the frame, the honeycomb arranged to break up light otherwise reflected from the solar panel, and a second honeycomb adjacent the back side and attached to the frame, the honeycomb arranged to dissipate heat from the solar panel.

### CROSS REFERENCE TO RELATED APPLICATION

This application claims priority to and the benefit of U.S. Provisional Application No. 62/242,787, filed Oct. 16, 2015, which is incorporated herein in its entirety.

### BACKGROUND

Users can deploy compact, portable solar arrays in trailers into tactical environments in which the solar power generated by the arrays becomes available for military units requiring mobile power to recharge their equipment such as communications, surveillance gear, etc. The arrays discussed here reside on mobile platforms such as trailers. With the trailer stationary, a center post extends itself out of the enclosure of the trailer. This allows the array of solar panels, mounted on a center, rotatable chord, to slide out of their stack configuration to form a relatively large solar array otherwise not attainable because of the confines of the trailer. The panels all connect to the rotatable, center chord to allow the array to rotate about the chord to track the movement of the sun.

An issue that arises in tactical environments, though, results from the shiny, reflective nature of the solar panels. These panels typically involve glass or other transparent, but sometimes reflective, surfaces. When the sun strikes the panels, some small amount of the light reflects. In tactical environments, the reflection can give away the position of the unit relying on the solar power.

### BRIEF DESCRIPTION OF THE DRAWINGS

FIG. 1 is a front and back view and a top down view of a non-glare, camouflage or ‘stealth’ arrangement for solar panels.

FIG. 2-4 show possible deployments of such a stealth arrangement on a portable, sun tracking, solar panel transportation device.

FIG. 5 shows a mobile solar platform during deployment.

### DETAILED DESCRIPTION OF THE EMBODIMENTS

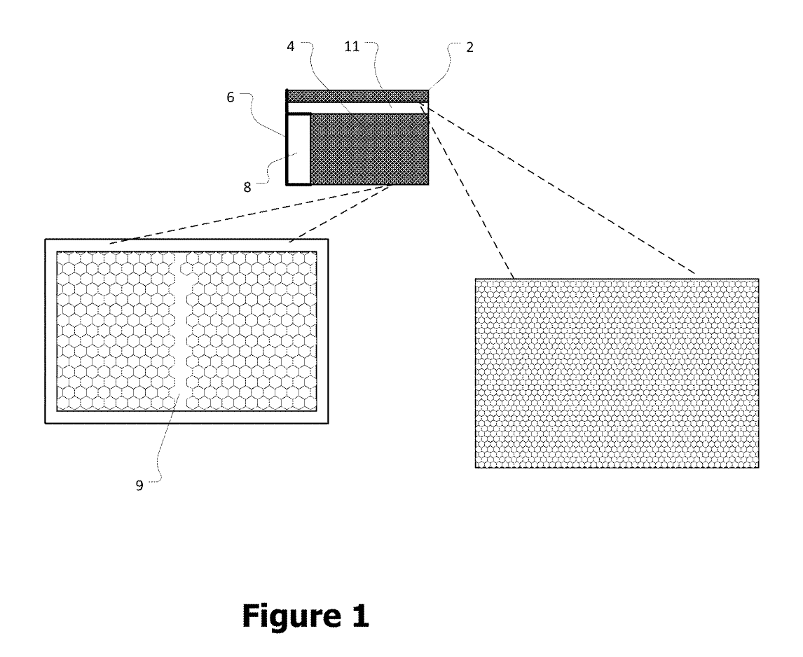

FIG. 1 shows two cells on the front and back of the solar panels. The cells are a honeycomb structure both on the front and the back of the solar panel. The front honeycomb structure prevents reflections and the read honeycomb reduces heat buildup in the panel.

When the panels deploy into a full array and move about the center chord, the back side of the panel may also reflect light, potentially giving away the position. The front cell 2 is a small honeycomb arrangement of non-reflective material that may also have a non-reflective coating. The panel 11 resides behind the front cell 2 consisting of a non-glare honeycombed material, such as polycarbonate. The polycarbonate may have a non-reflective coating such as military grade CARC (chemical agent resistant coating). Other material possibilities include plastics and other polymers. Non-reflective metals may also be used, including metals with coatings. Typically, metals and other more rigid materials may be used on the front face, as the back face may also act as a shock absorber, explained in more detail below.

The back cell 4 functions as a heat sink to wick heat from the frame and the front solar panel. This increases the efficiency of the solar panel and prevent heat from temporarily distorting or warping the frame that would cause the angle of incoming sunlight to lower the efficiency of the individual cells. The material selected for both the honeycomb cells and the frame are left up to the system designer, as they will depend upon the environment in which the system is to operate and the other materials used.

One should note that while the front honeycomb cell 2 in FIG. 1 has smaller individual cells than the back cell 4, these are just examples. The front cell could be bigger and the back cells smaller, they could have equal sizes, etc. Since the front side of the panel will typically have the more reflective surfaces, they may require smaller cells to break up any possible points of reflection. The reflectivity of the front side may also change depending upon the composition of the solar panels, so the honeycomb may adjust to different sizes depending upon the materials and applications. Further, the figures show the honeycomb shape as hexagonal, the individual cells may take any shape, including circular, octagonal, square, rectangular, etc.

In addition to preserving the tactical environment, the honeycomb ‘sandwich’ acts like a shock absorber for the glass panels when they are stacked in the travel configuration. In the top view of FIG. 1, one can see the front cell 2, the solar panel 11 and the back cell 4 held by a solar panel frame 6. There may be a void 8 in the solar panel frame. The void 6 may assist with managing heat and preventing heat warp to the frame holding the structure together. In addition, the heat sink honeycomb may have gaps such as 9 shown in the exploded view of the back honeycomb. These may allow for more efficient thermal management by allowing the heat collected in the heat sink honeycomb to dissipate into the atmosphere at periodic positions throughout the heat sink. While only one gap is shown, there may be several.

The solar panel 11, the honeycombs 2 and 4, with or without the gap 9 and the void 6, will be supported by the frame 6. The honeycombs and the solar panel are attached to the frame, where the term ‘attached’ includes those configurations where the honeycombs and solar panel are inserted into slots in the frame but not fastened to it, as if with screws, etc.

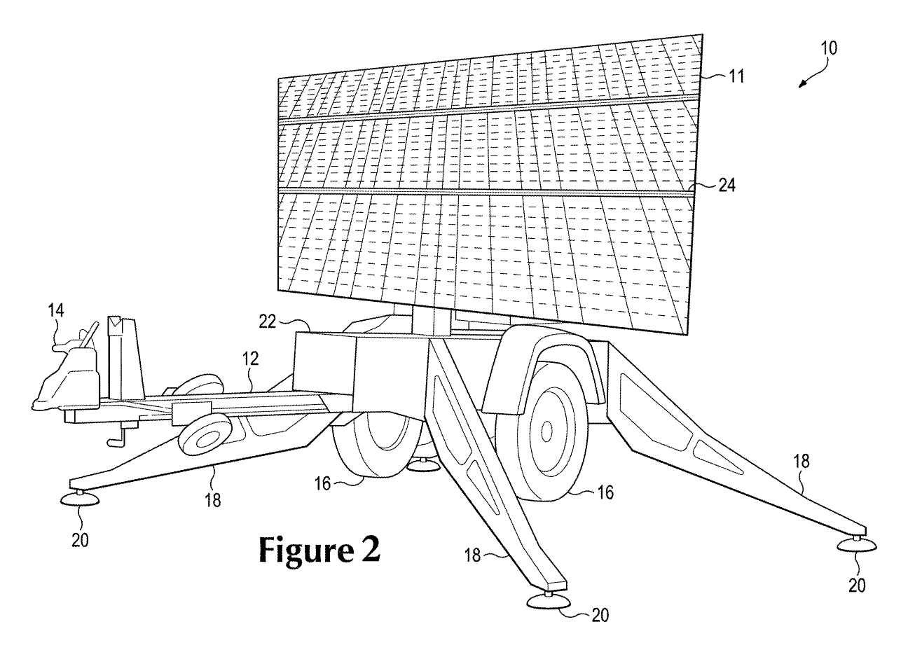

FIG. 2-4 show examples of trailer configurations and the panels in stacked and unstacking configurations. These drawings are adapted from U.S. patent application Ser. No. 13/839,796, which is incorporated herein in its entirety.

The platform shown in FIG. 2 consists of a trailer body 12 having a trailer ball receiver 14 for a connection to a typical trailer hitch. In an alternative embodiment, the trailer tongue uses a standard 3″ military pintle hook and eye. The trailer body 12 has standard-sized tires such as 16, making for easy replacement. In this embodiment they are 37″ military tires. The trailer body has 16-18″ of ground clearance, allowing transportation across rough terrain. In other applications, the tires, wheels, and axels may be removable to move them out of the way.

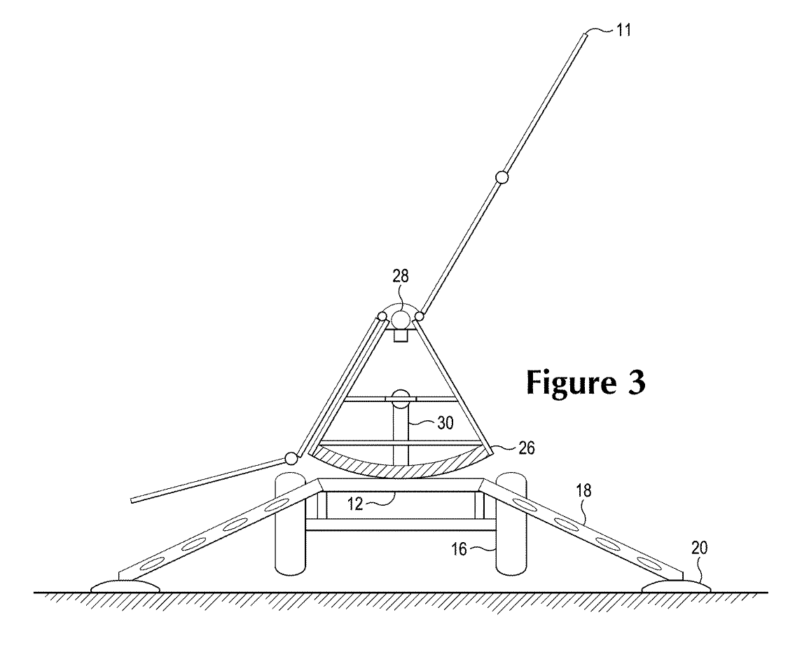

Once in place, the trailer has outriggers such as 18, having adjustable feet such as 20. These outriggers are hydraulic and remotely controllable. The control box 22 may include an interface control board (not shown) and a radio frequency, Bluetooth®, or other remote communications capability, allowing the outriggers to be lowered and raised from within another vehicle. This interface will also typically allow remote control of the positioning of the solar panels, as will be discussed in FIG. 3.

The array of solar panels such as 11 may have shock absorbers such as 24 between them to prevent damage to the panels while being transported, in addition to the shock absorber effect of the front and back honeycomb cells. The material used may be any material that provides a union or a joint between the panels that also allows for shock absorption. to lock the panels into place, the material may be rigid rather than flexible. The points of contact between the solar panel array and the trailer will also have some sort of shock absorbency to further ensure the safety of the panels. The back side of the panels, opposite to the side shown in FIG. 2, may consist of bullet proof materials.

The array of panels is mounted on a self-leveling truss, shown in more detail in FIG. 3. The panels couple to the trailer/towing assembly through a top cord 28, shown in end view in FIG. 3. In this embodiment, the top cord consists of a hinged coupler for rotating the panels into a solar facing configuration in one of many angles as shown. The top cord flexible assembly allows panels to stow and fold in both directions in excessive wind conditions. The top cord may also house a retractable reel that unwinds an adjustable foam cushion between panels to prevent glass damage during transport.

As mentioned previously, the control of the rotation may come from a communications interface that resides in the control box 22 of FIG. 2, or within the space frame 30, shown in FIG. 3. The self-leveling truss 26 mounts to the trailer body through a hydraulic gear 26 that allows the ‘turret’ to pan and tilt for the most efficient positioning of the solar panels.

Having discussed the overall configuration and capabilities of the mobile solar platform, with self-leveling and self-alignment, the discussion now moves to the capabilities. The control box or the space frame of the trailer body can support many different types of outlets, such as 24 volts direct current (VDC) and 120 volts alternating current (VAC). Further, for military application, where certain equipment uses rechargeable lithium-ion (Li-ON) batteries and ultra-capacitors, further connectors may be provided for their recharging, even while still in the vests worn by personnel using the battery-powered equipment such as night vision goggles, etc.

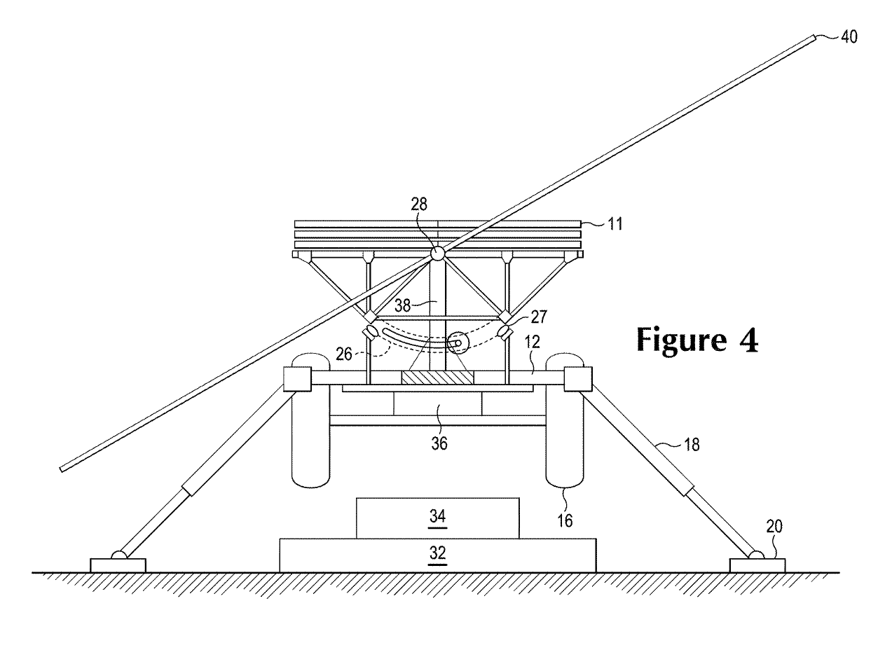

FIG. 4 shows an end view of an embodiment of a mobile solar platform 10. The arm 40 is a telescoping long arm that extends and pulls the panels from both sides of atop the solar array. Each panel is stacked in an accordion style at the end of the following panel. As the arm extends or retracts, the panels are folded as shown in the atop configuration. The embodiment uses thin film solar panels rather than a solid frame. The solar panel array may need additional support.

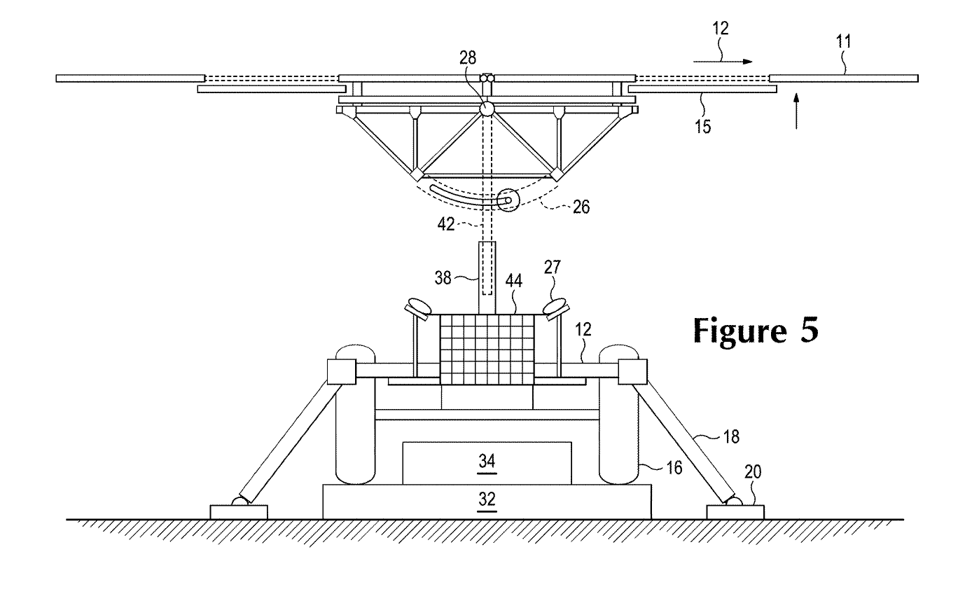

The trailer body 12 supports the movable truss 26 that in turn supports the solar panels 11. The solar panels are stackable as shown, or deployable into a large array of panels. The truss 26 allows the array of panels to deploy as shown by position 40, the panels having their honeycomb front and back cells, 42 and 44. The solar panels such as 11 move to form an array of solar panels that can rotate about the center chord 28. The truss 26 is cushioned by air bags or other shock absorbers 27. A center cylinder 28 may support the solar panel array, alternative to the embodiment of FIG. 2. This will be discussed in more detail in FIG. 5, showing the solid frame solar panel array.

The mobile solar platform will generally have at least one power storage to which the solar panels are electrically connected. In the embodiment of FIG. 4, a first battery back 36 may store enough power for 3 days and a second battery pack 34 may store enough power for 7-10 days. The mobile solar platform shown may have the outriggers such as 18 and feet 20 set out to hold the trailer body 12, or it may rest on the tires 16. Alternatively, the outriggers may be used to stabilize the platform, and the tires may rest on a flat rack such as 32, as shown in FIG. 5.

In FIG. 5, the center post 38 is shown to be a hydraulic cylinder with a center post 42. When extended, the cylinder allows the solar panel array to achieve heights that may allow the solar panels to receive more sunlight than if not extended. As shown in FIG. 4, the solar panels such as 11 are ‘unstacked’ or deployed into an array of solar panels. The stacking of the panels allows for easy transport on the trailer, especially in field conditions such as those experienced by the military, relief, and aid organizations such as the Red Cross® or the Federal Emergency Management Agency (FEMA).

The mobile solar platform may provide power for water sterilization components such as an LED-based water purification system 44 that uses ultraviolet LEDs to purify water. In addition, while in transport, top panels provide a trickle charge to batteries or capacitors. The front and back cells, 42 and 44, can act as shock absorbers between the panels in their stacked position. It will be appreciated that variants of the above-disclosed and other features and functions, or alternatives thereof, may be combined into many other different systems or applications.

Various presently unforeseen or unanticipated alternatives, modifications, variations, or improvements therein may be subsequently made by those skilled in the art which are also intended to be encompassed by the above discussion and the following claims.

What is claimed is:

1. A solar panel assembly, comprising:
a frame;
a solar panel attached to the frame, the solar panel having a front side to collect solar energy and a back side opposite the front side;
a first non-reflective honeycomb adjacent the front side and attached to the frame, the honeycomb arranged to break up light otherwise reflected from the solar panel;
a second honeycomb adjacent the back side and attached to the frame, the honeycomb arranged to dissipate heat from the solar panel.

2. The solar panel assembly of claim 1, wherein the first honeycomb comprises polycarbonate.

3. The solar panel assembly of claim 2, wherein the polycarbonate honeycomb has a non-reflective coating.

4. The solar panel assembly of claim 3, wherein the non-reflective coating comprises chemical agent resistant coating (CARC).

5. The solar panel assembly of claim 1, further comprising a void between the solar panel frame and the second honeycomb.

6. The solar panel assembly of claim 1, further comprising at least one gap in the second honeycomb.

7. The solar panel assembly of claim 1, wherein the solar panel assembly is mounted on a trailer.

8. The solar panel assembly of claim 7, wherein the solar panel assembly is one of many solar panel assemblies that are stackable.

9. The solar panel assembly of claim 8, wherein at least one of the first and second honeycombs act as shock absorbers between the solar panel assemblies when stacked.
